(19) United States
(12) Patent Application Publication
(10) Pub. No.: US 2026/0287390 A1
(43) Pub. Date: Sep. 24, 2026

(54) ELECTRONIC APPARATUS AND CONTROLLING METHOD THEREOF

(71) Applicant: SAMSUNG ELECTRONICS CO., LTD., Suwon-si (KR)

(72) Inventors: Yiyu LI, Nanjing (CN); Juan LIU, Nanjing (CN); Longhai WU, Nanjing (CN); Jie CHEN, Nanjing (CN); Hyuncheol PARK, Suwon-si (KR)

(73) Assignee: SAMSUNG ELECTRONICS CO., LTD., Suwon-si (KR)

(21) Appl. No.: 19/652,178

(22) Filed: Apr. 20, 2026

Related U.S. Application Data
(63) Continuation of application No. PCT/KR2026/002918, filed on Feb. 20, 2026.

(30) Foreign Application Priority Data
Mar. 20, 2025 (CN) 202510336897.3

(51) Int. Cl. G01C 21/00; G06V 10/26; G06V 20/10

(52) U.S. Cl. CPC G01C 21/383; G06V 10/273; G06V 20/10

(57) ABSTRACT

An electronic apparatus including: at least one processor including processing circuitry; a display; a camera; a sensor; and memory storing instructions and a map, wherein the instructions, when executed by the at least one processor individually or collectively, cause the electronic apparatus to: obtain, using the camera, an image related to a space in which the electronic apparatus is present, obtain a semantic feature based on the image, obtain a spatial feature representing a region of the space from a top-down viewpoint based on the semantic feature, update the map based on the spatial feature, obtain pose information of the electronic apparatus based on sensing data obtained by the sensor, and control the display to display a graphic user interface (GUI) corresponding to the pose information on the map.

### CROSS-REFERENCE TO RELATED APPLICATION

This application is a bypass continuation of International Application No. PCT/KR2026/002918, filed on Feb. 20, 2026, which is based on and claims priority to Chinese Patent Application No. 202510336897.3, filed on Mar. 20, 2025, in the China National Intellectual Property Administration, the disclosures of which are incorporated by reference herein in their entireties.

### BACKGROUND

### 1. Field

The present disclosure relates to the field of computer technology, and in particular to a lightweight map-based indoor positioning method and apparatus.

### 2. Description of Related Art

For unfamiliar and complex indoor environments, such as large apartments, office spaces, etc., it is often easy to get lost. Therefore, determining how to position a user in such indoor environments is particularly important.

In related art positioning technologies, such as a Global Positioning System (GPS) positioning technology, in urban areas, and especially in indoor environments, satellite signals are severely weakened after layers of obstruction and interference. Therefore, results are often not good. Solutions based on Wi-Fi, Bluetooth, infrared, or ultrasonic technology, etc. each have their own shortcomings affected by environmental factors (such as signal strength, transmission distance, and device hardware support). For SLAM positioning technology, vision-based SLAM can be affected by cumulative errors and is not suitable for long-term positioning. Laser-based SLAM, is often limited by cost, cannot be supported by most mobile devices, and provides results that are greatly affected by dynamic indoor environments. Existing methods based on image retrieval and two-dimensional (2D) image matching three-dimensional (3D) scenes (feature descriptors, point clouds, 3D reconstruction, etc.) require server-side storage of large spatial maps, which cannot support device-side computing and rely on network signals. In addition, existing visual positioning methods cannot effectively solve the problem of dynamic changes of the indoor environment.

Therefore, there is a need for an indoor positioning method that is not affected by dynamic environments and does not rely on network restrictions.

### SUMMARY

Provided is a lightweight map-based indoor positioning method and apparatus, which can achieve indoor positioning through a lightweight map without being affected by dynamic environments and without relying on networks.

According to an aspect of the disclosure, an electronic apparatus includes: at least one processor including processing circuitry; a display; a camera; a sensor; and memory storing instructions and a map, wherein the instructions, when executed by the at least one processor individually or collectively, cause the electronic apparatus to: obtain, using the camera, an image related to a space in which the electronic apparatus is present, obtain a semantic feature based on the image, obtain a spatial feature representing a region of the space from a top-down viewpoint based on the semantic feature, update the map based on the spatial feature, obtain pose information of the electronic apparatus based on sensing data obtained by the sensor, and control the display to display a graphic user interface (GUI) corresponding to the pose information on the map.

The image may be a two-dimensional image.

The semantic feature includes at least one of a layout element or a semantic element, the layout element may include information on a room structure, and the semantic element may be at least one device in a room.

The instructions, when executed by the at least one processor individually or collectively, may further cause the electronic apparatus to: extract semantic information from the image, identify at least one occluding element included in the image based on the semantic information, obtain a filtered image by filtering the at least one occluding element from the image, and obtain the layout element included in the filtered image based on the semantic information.

The instructions, when executed by the at least one processor individually or collectively, may further cause the electronic apparatus to: extract semantic information from the image, obtain a border line from the image based on the semantic information, obtain a segmentation mask from the image based on the border line, and obtain the semantic element in the image based on the segmentation mask.

The instructions, when executed by the at least one processor individually or collectively, may further cause the electronic apparatus to: obtain the semantic feature in a spatial two-dimensional perspective view space, obtain an intermediate feature by projecting the semantic feature from the spatial two-dimensional perspective view space to a three-dimensional world space through inverse perspective mapping, and obtain the spatial feature by projecting the intermediate feature from the three-dimensional world space to a top-down view space.

The instructions, when executed by the at least one processor individually or collectively, may further cause the electronic apparatus to: based on a first plurality of intermediate features of different types being projected to the same position in the three-dimensional world space, select one intermediate feature from among the first plurality of intermediate features according to a preset priority, and based on a second plurality of intermediate features of the same type being projected to the same position in the three-dimensional world space, obtain an average feature corresponding to the second plurality of intermediate features.

The map may lack visual appearance information and may include a spatial layout and a relationship of indoor elements.

The instructions, when executed by the at least one processor individually or collectively, may further cause the electronic apparatus to obtain the sensing data through at least one of an accelerometer sensor, a gyroscope sensor, a magnetometer sensor or Global Positioning System (GPS) sensor.

The pose information may include position data indicating a current location of the electronic apparatus in the space and direction data indicating an orientation of the electronic apparatus, and the GUI may indicate the current location of the electronic apparatus in the space and an orientation direction of the electronic apparatus on the map.

According to an aspect of the disclosure, a method of controlling an electronic apparatus, includes: obtaining an image related to a space in which the electronic apparatus is present, obtaining a semantic feature based on the image, obtaining a spatial feature representing a region of the space from a top-down viewpoint based on the semantic feature, updating, based on the spatial feature, a map of the space stored in memory of the electronic apparatus, obtaining pose information of the electronic apparatus based on sensing data, and displaying a Graphic User Interface (GUI) corresponding to the pose information on the map.

The image may be a two-dimensional image.

The semantic feature may include at least one of a layout element or a semantic element, the layout element may include information on a room structure, and the semantic element may be at least one device in a room.

The obtaining the semantic feature may include: extracting semantic information from the image; identifying at least one occluding element included in the image based on the semantic information; obtaining a filtered image by filtering the at least one occluding element from the image; and obtaining the layout element included in the filtered image based on the semantic information.

The obtaining the semantic feature may include: extracting semantic information from the image; obtaining a border line from the image based on the semantic information; obtaining a segmentation mask from the image based on the border line; and obtaining the semantic element in the image based on the segmentation mask.

According to an aspect of the disclosure, a non-transitory computer readable medium has instructions stored therein, which when executed by at least one processor cause the at least one processor to execute a method of operating an electronic apparatus, the method including: obtaining an image related to a space in which the electronic apparatus is present, obtaining a semantic feature based on the image, obtaining a spatial feature representing a region of the space from a top-down viewpoint based on the semantic feature, updating, based on the spatial feature, a map of the space stored in memory of the electronic apparatus, obtaining pose information of the electronic apparatus based on sensing data, and displaying a Graphic User Interface (GUI) corresponding to the pose information on the map.

The image may be a two-dimensional image.

The semantic feature may include at least one of a layout element or a semantic element, the layout element may include information on a room structure, and the semantic element may be at least one device in a room.

The obtaining the semantic feature may include: extracting semantic information from the image; identifying at least one occluding element included in the image based on the semantic information; obtaining a filtered image by filtering the at least one occluding element from the image; and obtaining the layout element included in the filtered image based on the semantic information.

The obtaining the semantic feature may include: extracting semantic information from the image; obtaining a border line from the image based on the semantic information; obtaining a segmentation mask from the image based on the border line; and obtaining the semantic element in the image based on the segmentation mask.

As provided herein, a two-dimensional image may be acquired by a mobile device, a current indoor pose of a user may be obtained based on a preset indoor positioning model, and a lightweight map may be displayed to the user to realize indoor positioning. When the indoor pose is determined by the preset indoor positioning model, semantic information are first extracted from the two-dimensional image to obtain semantic features, inverse perspective mapping is performed on the semantic features to generate bird’s-eye-view (BEV) features, then feature correction is performed based on the BEV features to obtain a complete BEV feature, and finally the complete BEV feature is matched with the preset lightweight map to obtain the indoor pose. This solution can achieve indoor positioning through a lightweight map without being affected by dynamic environments and without relying on networks.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a schematic diagram of a lightweight map according to one or more embodiments of the present disclosure;

FIG. 2 is a schematic structural diagram of a preset indoor positioning model according to one or more embodiments of the present disclosure;

FIG. 3 is a schematic diagram of obtaining layout elements according to one or more embodiments of the present disclosure;

FIG. 4 is a schematic diagram of obtaining semantic elements according to one or more embodiments of the present disclosure;

FIG. 5 is a schematic diagram of feature transformation according to one or more embodiments of the present disclosure;

FIG. 6 is a schematic diagram of projection of different types of BEVs according to one or more embodiments of the present disclosure;

FIG. 7 is a schematic flowchart of obtaining a preset feature repair sub-model according to one or more embodiments of the present disclosure;

FIG. 8 is a schematic flowchart of obtaining a reference BEV according to one or more embodiments of the present disclosure;

FIG. 9 is a schematic diagram of obtaining a first training sample set according to one or more embodiments of the present disclosure;

FIG. 10 is a schematic flowchart of obtaining a preset feature matching sub-model according to one or more embodiments of the present disclosure;

FIG. 11 is a schematic flowchart of lightweight map-based indoor positioning according to one or more embodiments of the present disclosure;

FIG. 12 is a schematic structural diagram of a lightweight map-based indoor positioning apparatus according to one or more embodiments of the present disclosure;

FIG. 13 is a schematic diagram of a physical structure of an electronic device according to one or more embodiments of the present disclosure; and

FIG. 14 is a schematic flowchart of controlling the electronic apparatus.

### DETAILED DESCRIPTION

The present disclosure is described in the following with reference to the accompanying drawings. The embodiments described herein are merely some rather than all the embodiments of the present disclosure. Based on the embodiments in the present disclosure, all other embodiments obtained by those of ordinary skill in the art without creative work fall within the scope of protection of the present disclosure.

The terms “first,” “second,” “third,” “fourth,” and the like, if present, in the description and claims of the present disclosure and in the foregoing drawings are used to distinguish similar objects, and are not necessarily used to describe the order or sequence of objects. It should be understood that data so used may be interchangeable where appropriate so that the embodiments of the present disclosure described herein, for example, can be carried out in an order other than those illustrated or described herein. Furthermore, the terms “include/comprise” and “have” and any variations thereof are intended to cover non-exclusive inclusions. For example, a process, method, system, product, or device that includes a series of operations or units need not be limited to those operations or units that are clearly listed, but may include other steps or units that are not clearly listed or inherent to the process, method, product, or device.

Terms such as “unit”, “module”, “member”, and “block” may be embodied as hardware or software. As used herein, a plurality of “units”, “modules”, “members”, and “blocks” may be implemented as a single component, or a single “unit”, “module”, “member”, and “block” may include a plurality of components.

It will be understood that when an element is referred to as being “connected” with or to another element, it can be directly or indirectly connected to the other element, wherein the indirect connection may include “connection via a wireless communication network”.

As used herein, the expressions “at least one of a, b or c” and “at least one of a, b and c” indicate “only a,” “only b,” “only c,” “both a and b,” “both a and c,” “both b and c,” and “all of a, b, and c.”

The present disclosure is described below in detail with reference to the accompanying drawings.

For unfamiliar and complex indoor environments, such as large apartments or office spaces, it is often easy to get lost. Therefore, how to position a user in such indoor environments is particularly important.

In the related positioning technologies, such as a GPS positioning technology, in urban areas, especially in indoor environments, satellite signals are severely weakened after layers of obstruction and interference. Therefore, the effect is not good. Solutions based on WIFI, Bluetooth, infrared, or ultrasonic technology, etc. each have their own shortcomings affected by environmental factors (such as signal strength, transmission distance, and device hardware support). For SLAM positioning technology, vision-based SLAM will be affected by cumulative errors and is not suitable for long-term positioning. Laser-based SLAM, limited by cost, cannot be supported by most mobile devices, and the results are greatly affected by dynamic indoor environments. Existing methods based on image retrieval and 2D image matching 3D scenes (feature descriptors, point clouds, 3D reconstruction, etc.) require server-side storage of large spatial maps, which cannot support device-side computing and rely on network signals. In addition, existing visual positioning methods cannot effectively solve the problem of dynamic changes of the indoor environment.

One or more embodiments of the present disclosure provide a lightweight map-based indoor positioning method. A two-dimensional image is acquired, a current indoor pose of a user may be obtained based on a preset indoor positioning model, and a lightweight map may be displayed to the user to realize indoor positioning. When the indoor pose is determined by the preset indoor positioning model, semantic information are first extracted from the two-dimensional image to obtain semantic features, next inverse perspective mapping is performed on the semantic features to generate BEV features, then feature correction is performed based on the BEV features to obtain a complete BEV feature, and finally the complete BEV feature is matched with the preset lightweight map to obtain the indoor pose. This solution can achieve indoor positioning through a lightweight map without being affected by dynamic environments and without relying on networks.

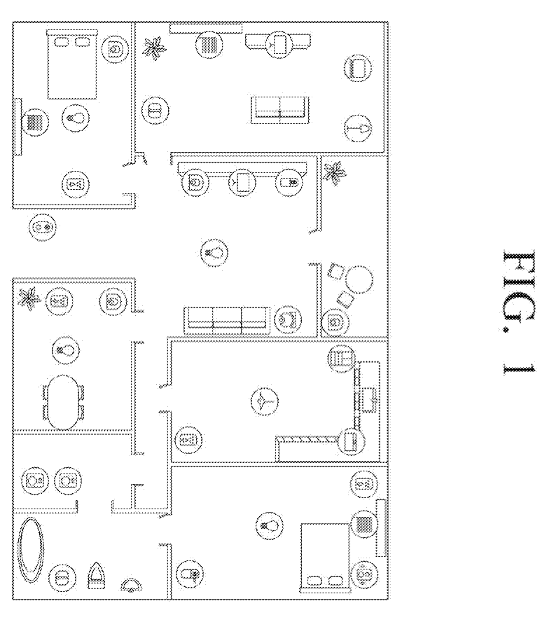

In one or more embodiments of the present disclosure, a map view, namely a lightweight map, is introduced. The lightweight map in this embodiment of the present disclosure is shown in FIG. 1. which is a schematic diagram of a lightweight map according to one or more embodiments of the present disclosure. The lightweight map in FIG. 1 discards visual appearance information, and only retains a spatial layout and relationship of indoor elements. For example, only elements that construct a room structure, such as walls, doors and windows, etc., electronic devices placed in the room, such as computers and TVs, furniture such as sofas and tables, and a spatial layout and relationship of these elements, such as a specific position of each element, and front-back, up-down, and left-right relationships of the elements are retained. FIG. 1 shows some exemplary elements, which are just an example. A lightweight map is generated according to an actual application scenario.

Compared with a realistic image map based on 3D reconstruction technology, the lightweight map herein needs less storage space, and the pressure on the storage space of a mobile device implementing this solution is relatively small, allowing most ordinary mobile devices to support this application. In addition, as long as the mobile device used in one or more embodiments of the present disclosure can acquire images, it is unnecessary to support some additional positioning functions and networks.

In one or more embodiments of the present disclosure, before performing indoor positioning based on the lightweight map, it is necessary to generate a preset lightweight map for a determined indoor scenario, and establish a preset indoor positioning model based on the preset lightweight map. A specific implementation process is provided below.

Different lightweight maps are used for different environments. Any lightweight map may be already present or directly generated. In one or more embodiments of the present disclosure, there is no limitation on a generation manner of the lightweight map.

In one or more embodiments of the present disclosure, when the indoor pose is determined for positioning by the preset indoor positioning model, semantic information are first extracted from the two-dimensional image to obtain semantic features, next inverse perspective mapping is performed on the semantic features to generate BEV features, then feature correction is performed based on the BEV features to obtain a complete BEV feature, and finally the complete BEV feature is matched with the preset lightweight map to obtain the indoor pose.

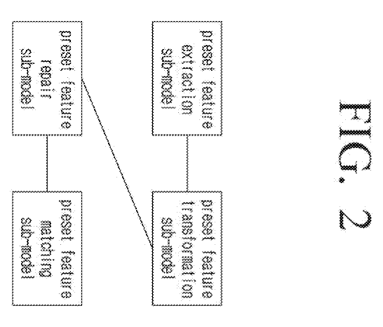

Referring to FIG. 2, FIG. 2 is a schematic structural diagram of a preset indoor positioning model according to one or more embodiments of the present disclosure. The preset indoor positioning model in FIG. 2 includes: a preset feature extraction sub-model, a preset feature transformation sub-model, a preset feature repair sub-model, and a preset feature matching sub-model.

The preset feature repair sub-model and the preset feature matching sub-model need to be trained on the basis of an established initial model. The preset feature extraction sub-model and the preset feature transformation sub-model may be directly established.

The preset feature extraction sub-model is configured to extract semantic information from the two-dimensional image to obtain semantic features. The preset feature transformation sub-model is configured to perform inverse perspective mapping on the semantic features to generate BEV features. The preset feature repair sub-model performs feature correction based on the BEV features to obtain a complete BEV feature. The preset feature matching sub-model is configured to match the complete BEV feature with the preset lightweight map to obtain the indoor pose.

The implementation of extracting semantic information from the two-dimensional image through the preset feature extraction sub-model to obtain semantic features is described as follows.

The semantic features obtained in one or more embodiments of the present disclosure include two parts: layout elements and semantic elements.

The layout elements are structural elements that construct the room structure, such as walls, doors and windows of the room. Consistent and clear layout clues can be provided even in dynamic scenarios, and the structural elements of the room structure here are usually unchanged.

The semantic elements are devices placed in the room, such as electronic devices, furniture, etc.

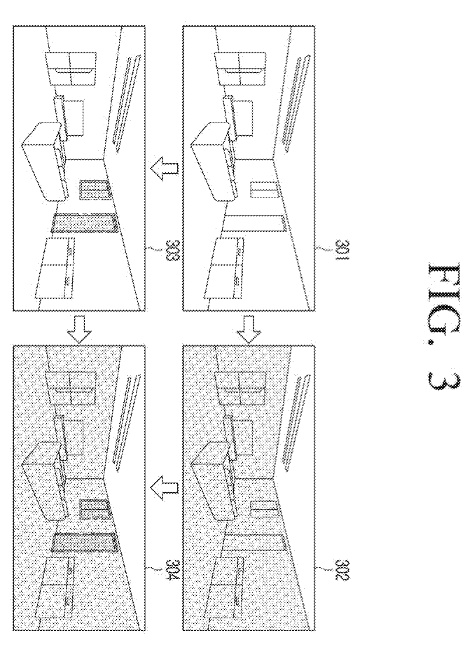

Referring to FIG. 3, FIG. 3 is a schematic diagram of obtaining layout elements according to one or more embodiments of the present disclosure. In FIG. 3, room layout estimation of the two-dimensional image is performed through the preset feature extraction sub-model to obtain the layout elements. Specifically, a CNN+LSTM deep network is used for predicting layout elements 302 (ceilings, walls, or floors) from a two-dimensional image 301. A 2D orthogonally transformed detection model is used for detecting a planar surface 303 representing doors and windows on each wall, while minimizing the influence of a viewpoint and perspective of a user, namely, filtering out elements that have an impact on the viewpoint and perspective of the user. The planar surface 303 of the doors and the windows on each wall and the predicted layout elements 302 are fused to obtain layout element information 304.

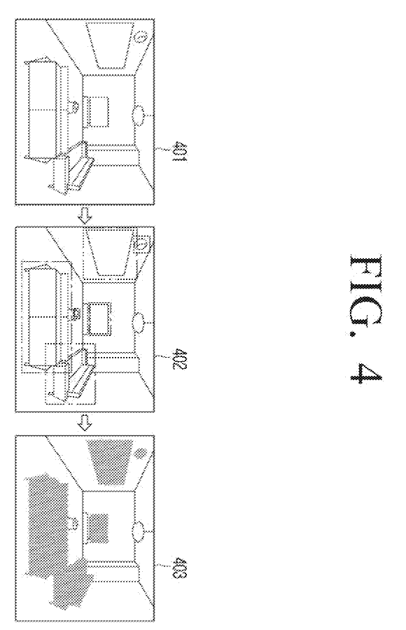

Referring to FIG. 4, FIG. 4 is a schematic diagram of obtaining semantic elements according to one or more embodiments of the present disclosure. The preset feature extraction sub-model in FIG. 4 obtains the semantic elements by instance segmentation. Specifically, a border 402 of semantic elements in a two-dimensional image 401 may be predicted by a customized object detector. Then a segmentation mask 403 corresponding to the two-dimensional image may be generated by a box prompt using an edge-based segmentation model, to obtain the semantic elements in the two-dimensional image.

The object detector herein may be trained on a subset of supported categories.

The implementation of performing inverse perspective mapping on the semantic features through the preset feature transformation sub-model to generate BEV features is described in detail as follows.

In order to recover hidden spatial information in a 3D space, features of each pixel are promoted, by inverse perspective mapping, from a 2D projection space (u, v) to a 3D world space (x, y, z), and then projected to a BEV space (x, y, 0). In the process of inverse perspective mapping, it is necessary to acquire intrinsic parameters and extrinsic parameters of an acquisition device for the two-dimensional image. These parameters may be obtained from the acquisition device.

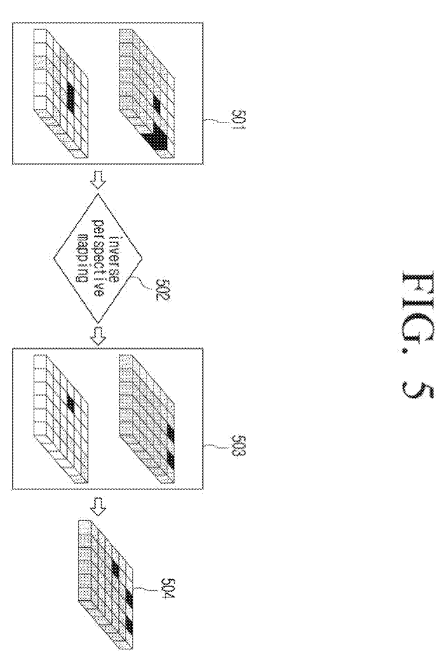

Referring to FIG. 5, FIG. 5 is a schematic diagram of feature transformation according to one or more embodiments of the present disclosure. A 2D perspective feature 501 of each pixel in FIG. 5 obtains BEV features 503 of a plurality of pixels through inverse perspective mapping 502. The BEV features 503 of the plurality of pixels are fused to obtain a fused BEV feature 504.

When the BEV features are fused, namely projected to the BEV space, the same or different pixel features may fall into the same position in the final BEV space. In order to maximize the preservation and maintain consistency with the lightweight map, the following projection rules are provided in one or more embodiments of the present disclosure.

If different types of BEVs are projected to a same two-dimensional spatial position, a priority of the semantic elements is greater than a priority of the layout elements, and the priority of the layout elements is greater than a priority of elements other than the semantic elements and the layout elements. To be specific, in this case, the priority of the semantic elements is the highest, followed by the priority of the layout elements, and finally, the priority of the elements other than the semantic elements and the layout elements is the lowest.

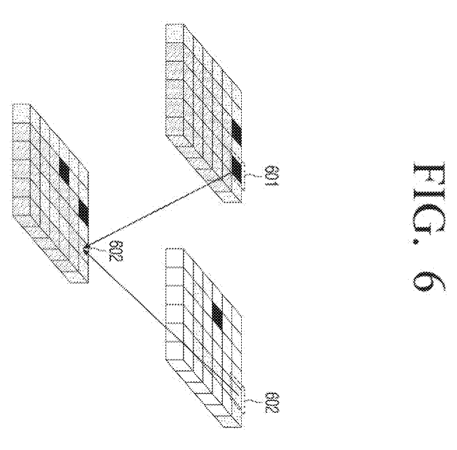

Referring to FIG. 6, FIG. 6 is a schematic diagram of projection of different types of BEVs according to one or more embodiments of the present disclosure. If a layout element 601 and a semantic element 602 need to be projected to a same position (x, y) in FIG. 6, the semantic element 602 is displayed at the position (x, y).

If a same type of BEVs are projected to the same two-dimensional spatial position, average features in a corresponding grid cell are used.

Due to blocking, some unobservable portions of 2D transmission images have no corresponding relationship in the BEV space, resulting in incomplete or inaccurate semantic features. By learning a real BEV representation of indoor elements in the field of view, a deep neural network is trained to obtain a preset feature repair sub-model to modify BEV features, and then obtain a complete BEV feature.

A training process of the preset feature repair sub-model is as follows.

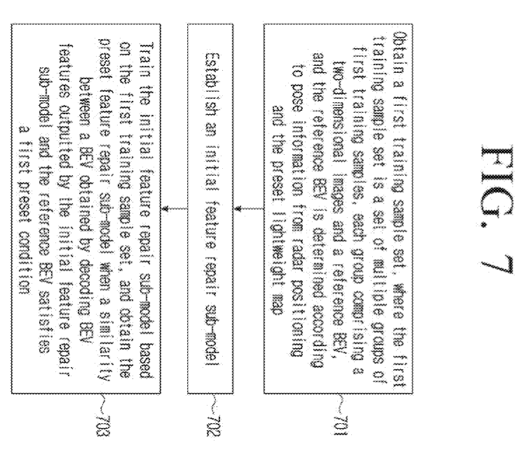

Referring to FIG. 7, FIG. 7 is a schematic flowchart of obtaining a preset feature repair sub-model according to one or more embodiments of the present disclosure. The specific operations are as follows.

Operation 701: Obtain a first training sample set, where the first training sample set is a set of multiple groups of first training samples, each group comprising a two-dimensional image and a reference BEV, and the reference BEV is determined according to pose information from radar positioning and the preset lightweight map.

The training of the preset feature repair sub-model requires a large amount of ground truth (GT) data (reference BEVs). In the related art, radar (LiDAR) may be used for generating a BEV occupancy grid map. However, LiDAR will scan each detail. Therefore, it will be affected in a dynamic scenario. Although 3D segmentation can solve this problem, the computational efficiency is very low. If a preset lightweight map is used as GT data, a deep neural network may indeed repair incomplete parts, but this may lead to unexpected “imagination” because GT contains unobservable parts from the user’s perspective.

In one or more embodiments of the present disclosure, a method for automatically generating GT data is provided, thereby preventing “imagination”. A corresponding relationship between a two-dimensional image and a pose is obtained by driving a robot in a corresponding indoor environment, so that the present disclosure can efficiently and accurately obtain a BEV, and then efficiently and accurately train to obtain a preset feature repair sub-model. The specific obtaining process is as follows.

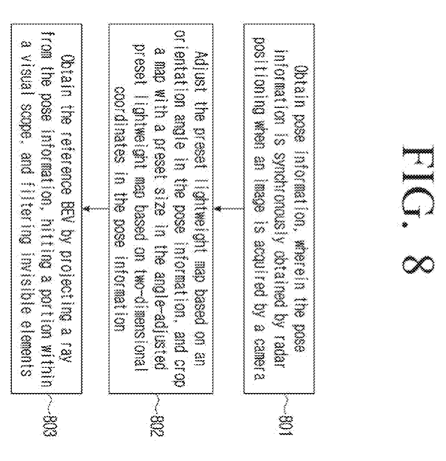

For obtaining of a reference BEV, refer to FIG. 8. FIG. 8 is a schematic flowchart of obtaining a reference BEV according to one or more embodiments of the present disclosure. The specific steps are as follows.

Operation 801: Obtain pose information, wherein the pose information is synchronously obtained by radar positioning when an image is acquired by a camera.

The two-dimensional image acquired herein corresponds to a reference BEV finally obtained through the pose information one to one as a set of training samples.

Operation 802: Adjust the preset lightweight map based on an orientation angle in the pose information, and crop a map with a preset size in the angle-adjusted preset lightweight map based on two-dimensional coordinates in the pose information.

Operation 803: Obtain the reference BEV by projecting a ray from the pose information, hitting a portion within a visual scope, and filtering invisible elements.

In order to simulate a real world viewed from the user’s perspective in this operation, the ray is emitted from the pose and hits an observable portion. An unobservable portion, such as something blocked behind a wall, is filtered out to avoid unnecessary illusions.

In one or more embodiments of the present disclosure, neural network parameters involved in the preset indoor positioning model are trained by automatically generating reference values in samples, so that the solution has practicability and scalability when deployed in various indoor environments.

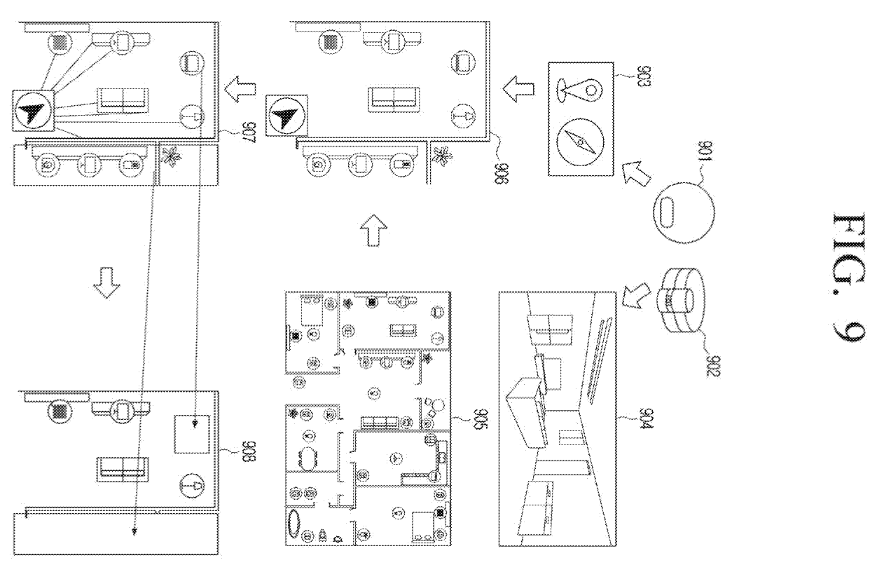

Referring to FIG. 9, FIG. 9 is a schematic diagram of obtaining a first training sample set according to one or more embodiments of the present disclosure. In FIG. 9, a radar 901 obtains pose information 903, while a camera 902 obtains a two-dimensional image 904. The pose information 903 and the two-dimensional image 904 obtained simultaneously are in a one-to-one correspondence.

A preset lightweight map 905 is adjusted based on an orientation angle in the pose information 903, and a map with a preset size is cropped in the angle-adjusted preset lightweight map based on two-dimensional coordinates in the pose information, to obtain a cropped lightweight map 906.

A reference BEV 908 is obtained by projecting a ray from the pose information, hitting a portion 907 within a visual scope of the cropped lightweight map, and filtering invisible elements.

Based on the one-to-one correspondence between the pose information 903 and the two-dimensional image 904, and the one-to-one correspondence between the reference BEV 908 and the corresponding two-dimensional image 904, the reference BEV 908 and the two-dimensional image 904 are used as a set of first training samples.

Operation 702: Establish an initial feature repair sub-model.

The initial feature repair sub-model herein may alternatively be an encoder. By learning the real BEV representation of indoor elements in the field of view, a deep neural network model is established as the initial feature repair sub-model.

Operation 703: Train the initial feature repair sub-model based on the first training sample set, and obtain the preset feature repair sub-model when a similarity between a BEV obtained by decoding BEV features outputted by the initial feature repair sub-model and the reference BEV satisfies a first preset condition.

The first preset condition herein may be set according to actual needs. For example, a preset threshold is set so that when the similarity is greater than the preset threshold, it is considered that the first preset condition is satisfied, and it may be determined that the training is completed.

Herein, it is also possible to establish a loss function, calculate a loss function value based on the reference BEV and a BEV obtained from the model, and perform gradient iteration to obtain a model with minimum errors as the preset feature repair sub-model. The specific training process is not limited herein.

The implementation of matching the complete BEV feature with the preset lightweight map through the feature matching sub-model to obtain the indoor pose is described in detail as follows.

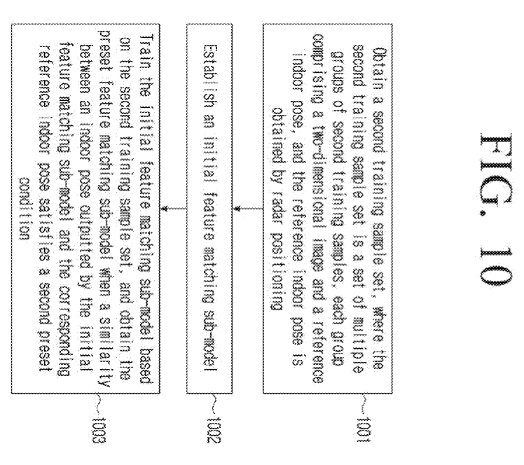

Referring to FIG. 10, FIG. 10 is a schematic flowchart of obtaining a preset feature matching sub-model according to one or more embodiments of the present disclosure. The specific operations are as follows.

Operation 1001: Obtain a second training sample set, where the second training sample set is a set of multiple groups of second training samples, each group comprising a two-dimensional image and a reference indoor pose, and the reference indoor pose is obtained by radar positioning.

When a two-dimensional image is acquired, an indoor pose is acquired at the same time, and the indoor pose is used as a reference pose to train an initial feature matching sub-model.

Operation 1002: Establish an initial feature matching sub-model.

Operation 1003: Train the initial feature matching sub-model based on the second training sample set, and obtain the preset feature matching sub-model when a similarity between an indoor pose outputted by the initial feature matching sub-model and the corresponding reference indoor pose satisfies a second preset condition.

The second preset condition herein may be that the similarity is greater than a second preset threshold, or a loss function may be established to determine a difference between an indoor pose outputted by the initial feature matching sub-model and the reference indoor pose to determine a training end condition. However, embodiments of the present disclosure are not limited thereto.

In one or more embodiments of the present disclosure, the structures of the initial feature matching sub-model and the preset feature matching sub-model are the same, both of them predict a positioning pose based on a module of a deep neural network (Transformer) in an end-to-end manner. The structure of the Transformer includes an encoder and a decoder. An input of the encoder of the Transformer is the repaired, i.e. a complete BEV feature. An input (query input) of the decoder of the Transformer is an encoded preset lightweight map. The encoded preset lightweight map is composed of learnable semantic embeddings and the poses of all indoor elements.

The Transformer uses a self-attention mechanism to capture a spatial relationship between the BEV features and map query elements separately, and then uses cross-attention to learn interrelationships between the BEV features and the map query elements.

A lightweight map matching result is outputted through the Transformer, and the lightweight map matching result is decoded into the indoor pose.

The feature matching sub-model is configured to match the complete BEV feature with the preset lightweight map to obtain the indoor pose, specifically including:

The complete BEV feature, namely the repaired BEV feature, is taken as an input to the encoder through position encoding and BEV feature tiling. The encoded preset lightweight map (semantic embedding information and poses of indoor elements) is taken as an input to the decoder. The mapping query is performed to obtain a query result, namely a matching result. Then the matching result is decoded into the indoor pose by MPL.

A lightweight map-based indoor positioning process according to one or more embodiments of the present disclosure will be described below with reference to the drawings.

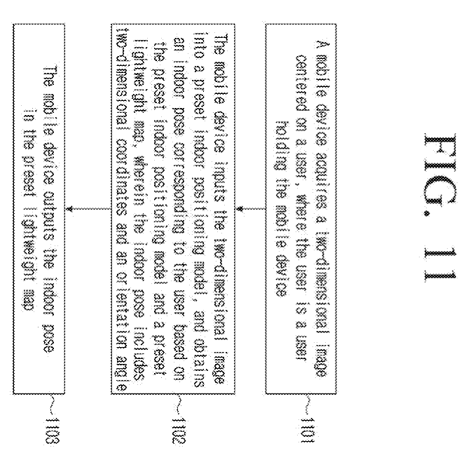

Referring to FIG. 11, FIG. 11 is a schematic flowchart of lightweight map-based indoor positioning according to one or more embodiments of the present disclosure. The specific operations are as follows.

Operation 1101: A mobile device acquires a two-dimensional image centered on a user, where the user is a user holding the mobile device.

Operation 1102: The mobile device inputs the two-dimensional image into a preset indoor positioning model, and obtains an indoor pose corresponding to the user based on the preset indoor positioning model and a preset lightweight map, wherein the indoor pose includes two-dimensional coordinates and an orientation angle.

The preset lightweight map is a map that discards visual appearance information and retains a spatial layout and relationship of indoor elements.

The preset indoor positioning model first extracts semantic information from the two-dimensional image to obtain semantic features, next performs inverse perspective mapping on the semantic features to generate BEV features, then performs feature correction based on the BEV features to obtain a complete BEV feature, and finally matches the complete BEV feature with the preset lightweight map to obtain the indoor pose.

Operation 1103: The mobile device outputs the indoor pose in the preset lightweight map.

In one or more embodiments of the present disclosure, the indoor pose may be obtained only by using a mobile device to acquire a two-dimensional image centered on a user and upload the image to a lightweight map-based indoor positioning apparatus deployed on the mobile device. This solution only requires visual information, does not rely on signals, and an established positioning model is robust to a dynamic scenario (by using more robust layout and semantic information to overcome the challenges of the dynamic scenario). The solution can be applied to different indoor environments, and indoor positioning can be realized based on lightweight maps.

According to the characteristics of a BEV based on lightweight maps in an established preset indoor positioning model, different types of element features are transformed and projected into the BEV, and the filtering of partially invisible elements and completely invisible elements is introduced to alleviate the problem of blocking. These implementations can improve the positioning accuracy through more accurate environmental feature modeling.

And neural network parameters involved in the preset indoor positioning model are trained by automatically generating reference values in samples, so that the solution has practicability and scalability when deployed in various indoor environments.

The lightweight map-based indoor positioning solution in this embodiment of the present disclosure may have a variety of applications, as follows.

The first type of application is indoor AR navigation.

A user who uses the positioning solution provided by this solution may get lost between different office buildings or floors, and the signal is insufficient for trilateral positioning. By using a mobile device to acquire a two-dimensional image in a self-centered manner and inputting the image to a lightweight map-based indoor positioning apparatus, an indoor pose of the user may be inputted on the preset lightweight map, allowing the user to know the position thereof shown on the map.

Further, it may be applied to navigation. For example, a user may input a destination in a preset lightweight map. Then positioning navigation may be performed for the user according to the destination and an indoor pose determined in one or more embodiments of the present disclosure.

The positioning function herein may further be extended to scenarios that require indoor positioning, such as assisting emergency responders in navigation in complex buildings while assisting endangered individuals in reporting their positions, and assisting Walmart/Amazon assistants in home deliveries, to provide real-time tracking and monitoring for delivery personnel to ensure that customers are not concerned about theft and privacy issues.

The second type of application is information recommendation based on geographical position personalization.

When a customer is in a large shopping mall, an indoor position of the customer may be determined through a two-dimensional picture provided by the customer, and nearby stores or products may be recommended to the customer according to the indoor pose.

The third type of application is smart home control.

The positioning solution according to one or more embodiments of the present disclosure enables an indoor automation system to trigger operations, such as light, temperature, and volume control, according to an indoor pose of a user, and these implementations may be made without signals or detection sensors.

All of the foregoing optional technical solutions may be arbitrarily combined to form optional embodiments of the present disclosure, and will not be described in detail herein.

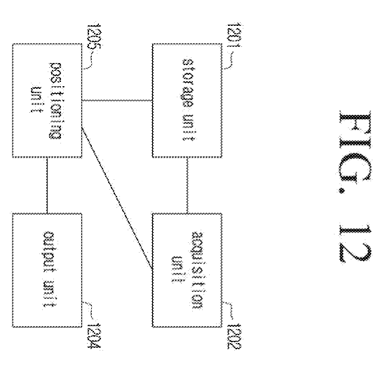

Based on the same concept, one or more embodiments of the present disclosure further provides a lightweight map-based indoor positioning apparatus, which is applied to a mobile device. Referring to FIG. 12, FIG. 12 is a schematic structural diagram of a lightweight map-based indoor positioning apparatus according to one or more embodiments of the present disclosure. The apparatus may include: a storage unit or memory 1201, configured to store a preset indoor positioning model and a preset lightweight map, wherein the preset indoor positioning model first extracts semantic information from a two-dimensional image to obtain semantic features, next performs inverse perspective mapping on the semantic features to generate BEV features, then performs feature correction based on the BEV features to obtain a complete BEV feature, and finally matches the complete BEV feature with the preset lightweight map to obtain an indoor pose, and the preset lightweight map is a map that discards visual appearance information and retains a spatial layout and relationship of indoor elements; an acquisition unit 1202, configured to acquire a two-dimensional image centered on a user, wherein the user is a user holding the mobile device; a positioning unit 1203, configured to input the two-dimensional image into the preset indoor positioning model, and obtain an indoor pose corresponding to the user based on the preset indoor positioning model and the preset lightweight map, wherein the indoor pose includes two-dimensional coordinates and an orientation angle; and an output unit 1204, configured to output the indoor pose in the preset lightweight map.

In another example, the preset indoor positioning model includes: a preset feature extraction sub-model, a preset feature transformation sub-model, a preset feature repair sub-model, and a preset feature matching sub-model. The preset feature extraction sub-model is configured to extract semantic information from the two-dimensional image to obtain semantic features. The preset feature transformation sub-model is configured to perform inverse perspective mapping on the semantic features to generate BEV features. The preset feature repair sub-model performs feature correction based on the BEV features to obtain a complete BEV feature. The preset feature matching sub-model is configured to match the complete BEV feature with the preset lightweight map to obtain the indoor pose.

In another example, the semantic features include: layout elements and semantic elements. The layout elements are elements that construct a room structure. The semantic elements are devices placed in a room.

The preset feature extraction sub-model is configured to extract semantic information from the two-dimensional image to obtain semantic features, including: obtaining the layout elements through room layout estimation, and filtering out elements that have an impact on a viewpoint and perspective of the user; and obtaining the semantic elements by instance segmentation.

In another example, The preset feature transformation sub-model is configured to perform inverse perspective mapping on the semantic features to generate BEV features, including:

promoting, by the preset feature transformation sub-model, the semantic features from a spatial two-dimensional perspective view space to a three-dimensional world space through inverse perspective mapping, and then projecting the semantic features to a BEV space to obtain the BEV features.

In another example, the positioning unit 1203 is specifically configured to: when projecting the semantic features to the BEV space, if different types of BEVs are projected to a same two-dimensional spatial position, a priority of the semantic elements is greater than a priority of the layout elements, and the priority of the layout elements is greater than a priority of elements other than the semantic elements and the layout elements; and if a same type of BEVs are projected to the same two-dimensional spatial position, use average features in a corresponding grid cell.

In another example, training of the preset feature repair sub-model in the storage unit 1201 includes: obtaining a first training sample set, where the first training sample set is a set of multiple groups of first training samples, each group comprising a two-dimensional image and a reference BEV, and the reference BEV is determined according to pose information from radar positioning and the preset lightweight map; establishing an initial feature repair sub-model; and training the initial feature repair sub-model based on the first training sample set, and obtaining the preset feature repair sub-model when a similarity between a BEV obtained by encoding and decoding BEV features outputted by the initial feature repair sub-model and the reference BEV satisfies a first preset condition.

In another example, the storage unit 1201 is further configured to determine the reference BEV according to pose information from radar positioning and the preset lightweight map, including: obtaining pose information, wherein the pose information is synchronously obtained by radar positioning when an image is acquired by a camera; adjusting the preset lightweight map based on an orientation angle in the pose information, and cropping a map with a preset size in the angle-adjusted preset lightweight map based on two-dimensional coordinates in the pose information; and obtaining the reference BEV by projecting a ray from the pose information, hitting a portion within a visual scope, and filtering invisible elements.

In another example, the positioning unit 1203 is specifically configured to: when matching the complete BEV feature with the preset lightweight map to obtain the indoor pose, predict, by the feature matching sub-model, the indoor pose based on a Transformer; take the complete BEV feature as an input to an encoder of the Transformer; take the encoded preset lightweight map as an input to a decoder of the Transformer; and output a lightweight map matching result through the Transformer, and decode the lightweight map matching result into the indoor pose.

In another example, training of the preset feature matching sub-model in the storage unit 1201 includes: obtaining a second training sample set, wherein the second training sample set is a set of multiple groups of second training samples, each group comprising a two-dimensional image and a reference indoor pose, and the reference indoor pose is obtained by radar positioning; establishing an initial feature matching sub-model; and training the initial feature matching sub-model based on the second training sample set, and obtaining the preset feature matching sub-model when a similarity between an indoor pose outputted by the initial feature matching sub-model and the corresponding reference indoor pose satisfies a second preset condition.

The units of the foregoing embodiment may be integrated or separately deployed, and may be merged into one unit or further split into a plurality of sub-units.

In another embodiment, an electronic device is further provided, including a memory, a processor, and a computer program stored on the memory and executable on the processor. The processor, when executing the program, implements a lightweight map-based indoor positioning method.

In another embodiment, a computer-readable storage medium having a computer instruction stored thereon is further provided. The instruction, when executed by a processor, implements a lightweight map-based indoor positioning method.

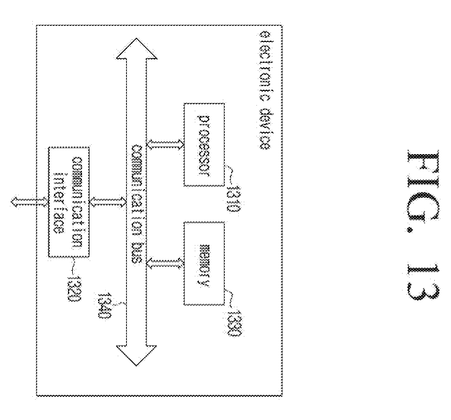

FIG. 13 is a schematic diagram of a physical structure of an electronic device according to one or more embodiments of the present disclosure. As shown in FIG. 13, the electronic device may include: at least one processor 1310, a communication interface 1320, memory 1330, and a communication bus 1340. The processor 1310, the communication interface 1320, and the memory 1330 communicate with each other through the communication bus 1340. The processor 1310 may call logic instructions in the memory 1330 to perform the following methods: acquiring a two-dimensional image centered on a user, where the user is a user holding a mobile device; obtaining an indoor pose corresponding to the user based on a preset indoor positioning model and a preset lightweight map, where the indoor pose includes two-dimensional coordinates and an orientation angle, and the preset lightweight map is a map that discards visual appearance information and retains a spatial layout and relationship of indoor elements; and outputting the indoor pose in the preset lightweight map.

The preset indoor positioning model first extracts semantic information from the two-dimensional image to obtain semantic features, next performs inverse perspective mapping on the semantic features to generate BEV features, then performs feature correction based on the BEV features to obtain a complete BEV feature, and finally matches the complete BEV feature with the preset lightweight map to obtain the indoor pose.

Furthermore, the logic instructions in the memory 1330 may be stored in a computer-readable storage medium when implemented in the form of software functional units and sold or used as stand-alone products. Based on this understanding, the technical solution of the present disclosure essentially or contributes to the related art or a part of the technical solution may be embodied in the form of a software product. The computer software product is stored in a storage medium and includes several instructions for causing a computer device (which may be a personal computer, a server, or a network device) to perform all or part of the operations of the methods according to one or more embodiments of the present disclosure. The foregoing storage medium includes: various media capable of storing program codes, such as a USB flash drive, a removable hard disk, a read-only memory (ROM), a random access memory (RAM), a magnetic disk, or an optical disk.

The apparatus embodiment described above is merely schematic, where the units described as separate components may or may not be physically separate, and the components shown as units may or may not be physical units. To be specific, they may be located in one place or may be distributed over a plurality of network units. Some or all of the modules may be selected according to actual needs to achieve the purpose of the solution of this embodiment. It may be understood and implemented by those of ordinary skill in the art without creative effort.

From the foregoing description of the implementations, those skilled in the art will clearly understand that each implementation may be achieved by software plus a necessary general hardware platform, or by hardware. Based on this understanding, the foregoing technical solution essentially or contribute to the related art may be embodied in the form of a software product. The computer software product may be stored in a computer-readable storage medium, such as a ROM/RAM, a magnetic disk, or an optical disk, and includes several instructions for causing a computer device (which may be a personal computer, a server, or a network device) to perform the methods described in one or more embodiments or some portions of the embodiments.

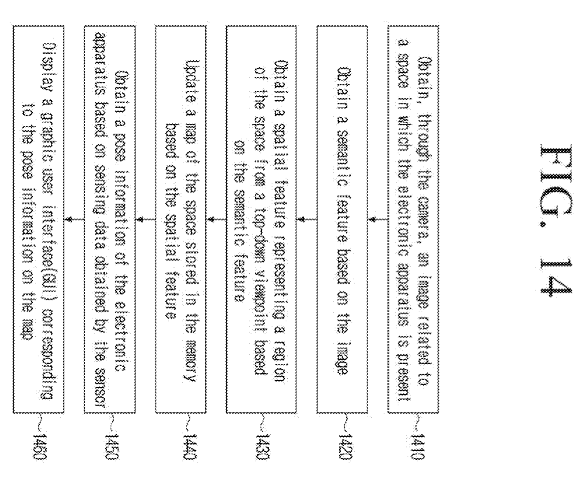

FIG. 14 is a schematic flowchart of controlling the electronic apparatus.

An electronic apparatus may include at least one processor including processing circuitry, a display, a camera, a sensor and memory storing instructions.

A method of controlling an electronic apparatus, the method includes obtaining an image related to a space in which the electronic apparatus is present (S1410), obtaining a semantic feature based on the image (S1420), obtaining a spatial feature representing a region of the space from a top-down viewpoint based on the semantic feature (S1430), updating a pre-stored map of the space stored in the electronic apparatus based on the spatial feature (S1440), obtaining pose information of the electronic apparatus based on sensing data (S1450), and displaying a graphic user interface (GUI) corresponding to the pose information on the pre-stored map (S1460).

An electronic apparatus may be a device configured to perform sensing, processing, and display operations. The electronic apparatus may be described as the mobile device or a movable device.

The at least one processor may obtain, through the camera, an image related to a space in which the electronic apparatus may be present. The space may be a physical environment in which the electronic apparatus may be located.

In an example, the camera may be a 2D-camera. The image may be a two-dimensional image. The image related to a space in which the electronic apparatus is present may be described as the two-dimensional image centered on a user. The image may be described as the two-dimensional image.

The at least one processor may obtain a semantic feature based on the image.

The semantic feature may be feature data extracted from the image and representing semantic information of the space. The semantic feature may include at least one of layout element or semantic element.

The mantic feature may be feature information extracted from an image to represent meaningful components of a space. The semantic feature may be feature information representing indoor elements of a space. The semantic feature may represent structural components of a room. The semantic feature may represent elements of a space excluding visual appearance information. The semantic feature may represent spatially meaningful elements identified in an image. The semantic feature may include a layout element representing a structure of a room.

The semantic feature may be described as semantic information, semantic representation, semantic data, or semantic descriptor.

The layout element may be an element that constructs a room structure. The layout element may be obtained based on semantic information extracted from an image. The layout element may represent structural components of an indoor space. The layout element may represent boundaries of a room. The layout element may represent a spatial layout of a room.

The layout element may be described as a structural element, a room-structure element, a spatial layout element, or a structural layout component.

In an example, the semantic element may be at least one device placed in a room.

The at least one processor may extract semantic information from the image. The semantic information may be information extracted from an image that indicates meaningful elements of a space. The semantic information may be cues used to identify structural elements or devices in an image. The semantic clue may be described as semantic cue or semantic indicator.

The at least one processor may obtain at least one occluding element included in the image based on the semantic information. The occluding element may be an element in an image that blocks or partially obscures a view of another element or a region of a space. The occluding element may be an object or structure that interferes with visual identification of layout elements or semantic elements in the image.

The occluding element may be described as an occlusion element, a visual obstruction, an occluding object or an obstructing element.

The at least one processor may obtain a filtered image by filtering the at least one occluding element from the image. The filtered image may be an image in which regions corresponding to occluding elements are filtered out. The filtered image may be described as an occlusion-removed image, an occlusion-filtered image, an obstruction-removed image or a cleaned image.

The at least one processor may obtain the layout element included in the filtered image based on the semantic information.

The at least one processor may extract semantic information from the image. The at least one processor may obtain a border line from the image based on the semantic information. The border line may be a line corresponding to an outline of an element identified based on semantic information. The border line may be described as an edge line, a segmentation boundary, a region contour or a semantic boundary.

The at least one processor may obtain a segmentation mask from the image based on the border line. The at least one processor may obtain the semantic element in the image based on the segmentation mask.

The segmentation mask may be data indicating a region of an image corresponding to a specific element. The segmentation mask may be data representing pixel-level regions separated based on a border line. The segmentation mask may be data used to distinguish a semantic element from other regions in the image.

The segmentation mask may be described as a segmentation map, a region mask, a pixel mask or a mask image.

The at least one processor may obtain a spatial feature representing a region of the space from a top-down viewpoint based on the semantic feature.

The at least one processor may obtain the semantic feature in a spatial two-dimensional perspective view space. The spatial two-dimensional perspective view space may be a coordinate space corresponding to an image captured from a camera viewpoint. The semantic feature in the spatial two-dimensional perspective view space may be semantic information represented in an image-based coordinate system. The spatial two-dimensional perspective view space may be described as an image view space, a camera view space, a perspective image space or a two-dimensional camera space.

The at least one processor may obtain an intermediate feature by projecting the semantic feature from the spatial two-dimensional perspective view space to a three-dimensional world space through inverse perspective mapping. The three-dimensional world space may be a coordinate space representing a physical space in which the electronic apparatus is located. The intermediate feature may be feature information represented in the three-dimensional world space and derived from the semantic feature. The three-dimensional world space may be described as a physical space, a world coordinate space, a real-world space or a three-dimensional spatial coordinate system.

The at least one processor may obtain the spatial feature by projecting the intermediate feature from the three-dimensional world space to a top-down view space. The top-down view space may be a coordinate space representing the space from an overhead viewpoint. The spatial feature may be feature information representing a region of the space in the top-down view space. The spatial feature may represent a spatial layout of the space independently of a camera perspective. The top-down view space may be described as a bird’s-eye view space, an overhead view space, a planar top-view space or a ground-plane view space. The top-down viewpoint may be described as a bird’s eye view (BEV).

The spatial feature may be feature information representing a region of a space from a top-down viewpoint. The spatial feature may be feature information expressed in a top-down view space. The spatial feature may be described as a top-down spatial feature, a planar spatial representation, a spatial layout feature or a top-view feature representation.

The spatial feature may be described as the BEV feature. The intermediate feature may be described as an intermediate BEV feature.

Based on a first plurality of intermediate features of a different type being projected to the same position in the three-dimensional world space, the at least one processor may select one intermediate feature according to a preset priority, and

Based on a second plurality of intermediate features of the same type being projected to the same position in the three-dimensional world space, the at least one processor may obtain an average feature corresponding to the second plurality of intermediate features.

The at least one processor may obtain an intermediate feature set in which conflicts and redundancies at the same spatial position are removed. The at least one processor may consolidate a plurality of intermediate features projected to the same position into a single representative intermediate feature. The at least one processor may use the consolidated intermediate features to project the features into a top-down view space and generate a stable spatial feature.

The at least one processor may update a pre-stored map of the space stored in the memory based on the spatial feature. The pre-stored map may be a map that discards visual appearance information and retains a spatial layout and relationship of indoor elements. The pre-stored map may be map information stored in the memory prior to updating. The pre-stored map may represent an indoor space independently of image appearance information. The pre-stored map may be described as an indoor map, a spatial layout map, a structure-based map or a layout map. The pre-stored map may be described as the preset lightweight map.

The at least one processor may obtain pose information of the electronic apparatus based on sensing data obtained by the sensor. The at least one processor may obtain the sensing data through at least one of an accelerometer sensor, a gyroscope sensor, a magnetometer sensor or Global Positioning System (GPS) sensor. The sensing data may be described as radar positioning data.

The pose information may be information indicating a position and an orientation of the electronic apparatus. The pose information may represent a state of the electronic apparatus in a space. The pose information may be described as spatial state information, device pose data, positional orientation information or spatial location information.

The at least one processor may control the display to display a GUI corresponding to the pose information on the pre-stored map.

The pose information may include position data indicating a current location of the electronic apparatus in the space and direction data indicating an orientation of the electronic apparatus. The pose information may be described as the indoor pose. The position data may be described as the two-dimensional coordinates. The direction data may be described as the orientation angle.

The GUI may indicate the current position of the electronic apparatus in the space and the orientation direction of the electronic apparatus on the pre-stored map. Displaying a GUI may be described as outputting the indoor pose.

The GUI may visually represent a current position of the electronic apparatus in a space. The GUI may visually represent an orientation direction of the electronic apparatus in the space. The GUI may include graphical elements overlaid on the pre-stored map. The GUI may be a visual interface that displays position and orientation information of the electronic apparatus on the pre-stored map.

The flowcharts and block diagrams in the accompanying drawings of the present disclosure illustrate the architecture, functionality, and operation of possible implementations of systems, methods, and computer program products in accordance with one or more embodiments disclosed in the present disclosure. In this regard, each block in the flowchart or block diagram may represent a module, a program segment, or a portion of code. The module, the program segment, or the portion of code contains one or more executable instructions for implementing a specified logical function. It should also be noted that, in some alternative implementations, the functions noted in the blocks may also occur in an order in different drawings. For example, two blocks represented in connection may actually be executed substantially in parallel, and may sometimes be executed in reverse order, depending on the function involved. It should also be noted that, each block in the block diagram or flowchart, and combinations of blocks in the block diagram or flowchart, may be implemented with a dedicated hardware-based system that performs a specified function or operation, or may be implemented with a combination of dedicated hardware and computer instructions.

Those skilled in the art may understand that various combinations and/or integrations of features described in one or more embodiments and/or claims disclosed in the present disclosure may be made, even if such combinations or integrations are not explicitly described in the present disclosure. In particular, the features recited in one or more embodiments and/or claims of the present disclosure may be combined and/or integrated in various ways, all of which fall within the scope of the present disclosure without departing from the spirit and teachings of the present disclosure.

The principles and implementations of the present disclosure are described with reference to specific embodiments herein. The description of the foregoing embodiments is only for helping to understand the method of the present disclosure and the core concept thereof, and is not intended to limit the present disclosure. For those skilled in the art, changes may be made in the specific implementations and application scope according to the idea, spirit, and principles of the present disclosure, and any modifications, equivalent substitutions, improvements, etc. made thereto should be included within the protection scope of the present disclosure.

What is claimed is:

1. An electronic apparatus comprising:
at least one processor including processing circuitry;
a display;
a camera;
a sensor; and
memory storing instructions and a map,
wherein the instructions, when executed by the at least one processor individually or collectively, cause the electronic apparatus to:
obtain, using the camera, an image related to a space in which the electronic apparatus is present,
obtain a semantic feature based on the image,
obtain a spatial feature representing a region of the space from a top-down viewpoint based on the semantic feature,
update the map based on the spatial feature,
obtain pose information of the electronic apparatus based on sensing data obtained by the sensor, and
control the display to display a graphic user interface (GUI) corresponding to the pose information on the map.

2. The electronic apparatus of claim 1, wherein the image is a two-dimensional image.

3. The electronic apparatus of claim 1, wherein the semantic feature comprises at least one of a layout element or a semantic element,
wherein the layout element comprises information on a room structure, and
wherein the semantic element is at least one device in a room.

4. The electronic apparatus of claim 3, wherein the instructions, when executed by the at least one processor individually or collectively, further cause the electronic apparatus to:
extract semantic information from the image,
identify at least one occluding element included in the image based on the semantic information,
obtain a filtered image by filtering the at least one occluding element from the image, and
obtain the layout element included in the filtered image based on the semantic information.

5. The electronic apparatus of claim 3, wherein the instructions, when executed by the at least one processor individually or collectively, further cause the electronic apparatus to:
extract semantic information from the image,
obtain a border line from the image based on the semantic information,
obtain a segmentation mask from the image based on the border line, and
obtain the semantic element in the image based on the segmentation mask.

6. The electronic apparatus of claim 1, wherein the instructions, when executed by the at least one processor individually or collectively, further cause the electronic apparatus to:
obtain the semantic feature in a spatial two-dimensional perspective view space,
obtain an intermediate feature by projecting the semantic feature from the spatial two-dimensional perspective view space to a three-dimensional world space through inverse perspective mapping, and
obtain the spatial feature by projecting the intermediate feature from the three-dimensional world space to a top-down view space.

7. The electronic apparatus of claim 6, wherein the instructions, when executed by the at least one processor individually or collectively, further cause the electronic apparatus to:
based on a first plurality of intermediate features of different types being projected to the same position in the three-dimensional world space, select one intermediate feature from among the first plurality of intermediate features according to a preset priority, and
based on a second plurality of intermediate features of the same type being projected to the same position in the three-dimensional world space, obtain an average feature corresponding to the second plurality of intermediate features.

8. The electronic apparatus of claim 1, wherein the map lacks visual appearance information and comprises a spatial layout and a relationship of indoor elements.

9. The electronic apparatus of claim 1, wherein the instructions, when executed by the at least one processor individually or collectively, further cause the electronic apparatus to:
obtain the sensing data through at least one of an accelerometer sensor, a gyroscope sensor, a magnetometer sensor or Global Positioning System (GPS) sensor.

10. The electronic apparatus of claim 1, wherein the pose information comprises position data indicating a current location of the electronic apparatus in the space and direction data indicating an orientation of the electronic apparatus, and
wherein the GUI indicates the current location of the electronic apparatus in the space and an orientation direction of the electronic apparatus on the map.

11. A method of controlling an electronic apparatus, the method comprising:
obtaining an image related to a space in which the electronic apparatus is present;
obtaining a semantic feature based on the image;
obtaining a spatial feature representing a region of the space from a top-down viewpoint based on the semantic feature;
updating, based on the spatial feature, a map of the space stored in memory of the electronic apparatus;
obtaining pose information of the electronic apparatus based on sensing data; and
displaying a Graphic User Interface (GUI) corresponding to the pose information on the map.

12. The method of claim 11, wherein the image is a two-dimensional image.

13. The method of claim 11, wherein the semantic feature comprises at least one of a layout element or a semantic element,
wherein the layout element comprises information on a room structure, and
wherein the semantic element is at least one device in a room.

14. The method of claim 13, wherein the obtaining the semantic feature comprises:
extracting semantic information from the image;
identifying at least one occluding element included in the image based on the semantic information;
obtaining a filtered image by filtering the at least one occluding element from the image; and
obtaining the layout element included in the filtered image based on the semantic information.

15. The method of claim 13, wherein the obtaining the semantic feature comprises:
extracting semantic information from the image;
obtaining a border line from the image based on the semantic information;
obtaining a segmentation mask from the image based on the border line; and
obtaining the semantic element in the image based on the segmentation mask.

16. A non-transitory computer readable medium having instructions stored therein, which when executed by at least one processor cause the at least one processor to execute a method of operating an electronic apparatus, the method comprising:
obtaining an image related to a space in which the electronic apparatus is present;
obtaining a semantic feature based on the image;
obtaining a spatial feature representing a region of the space from a top-down viewpoint based on the semantic feature;
updating, based on the spatial feature, a map of the space stored in memory of the electronic apparatus;
obtaining pose information of the electronic apparatus based on sensing data; and
displaying a Graphic User Interface (GUI) corresponding to the pose information on the map.

17. The non-transitory computer readable medium of claim 16, wherein the image is a two-dimensional image.

18. The non-transitory computer readable medium of claim 16, wherein the semantic feature comprises at least one of a layout element or a semantic element,
wherein the layout element comprises information on a room structure, and
wherein the semantic element is at least one device in a room.

19. The non-transitory computer readable medium of claim 18, wherein the obtaining the semantic feature comprises:
extracting semantic information from the image;
identifying at least one occluding element included in the image based on the semantic information;
obtaining a filtered image by filtering the at least one occluding element from the image; and
obtaining the layout element included in the filtered image based on the semantic information.

20. The non-transitory computer readable medium of claim 18, wherein the obtaining the semantic feature comprises:
extracting semantic information from the image;
obtaining a border line from the image based on the semantic information;
obtaining a segmentation mask from the image based on the border line; and
obtaining the semantic element in the image based on the segmentation mask.
